(19) United States
(12) Patent Application Publication
(10) Pub. No.: US 2006/0115576 A1
(43) Pub. Date: Jun. 1, 2006

(54) Low-cholesterol shrimp and method of obtaining same

(76) Inventors: Inocencio Higuera Ciapara, Sonora (MX); Alma Rosa Toledo Guillen, Sonora (MX); Lorena Olivia Noriega Orozco, Sonora (MX); Karla Guadalupe Martinez Robinson, Sonora (MX)

Correspondence Address: Charles Berman;Greenberg Traurig, 2450 Colorado Avenue, Suite 400E, Santo Monica, CA, 90404, US

(21) Appl. No.: 10/525,435

(22) PCT Filed: Aug. 22, 2002
(86) PCT No.: PCT/MX02/00083

§ 371 Date: Feb. 22, 2005

(51) Int. Cl. A23L 1/325

(52) U.S. Cl. 426/643

(57) ABSTRACT

It is disclosed a low-cholesterol whole shrimp a method of obtaining same comprising: (a) to provide a plurality of frozen, peeled and deheaded shrimps; (b) to freeze drying the whole shrimps to a humidity content of approximately 1 to 10%; (c) to extract the cholesterol from the dehydrated shrimps by means of a stream of a supercritical solvent which is selective to lipids, at a temperature between 36-39° C. and at a pressure between 275-345 bar; (d) to rehydrate the shrimps in a vacuum chamber with water in a relationship of about 1-10 mL per g shrimp at vacuum and room temperature by about 1-5 hours; and (e) to cook said plurality of whole shrimp with steam.

This invention refers to a low-cholesterol shrimp which can be marketed for human consumption. More specifically, the invention is related to the problem of producing foods with low cholesterol content in the light of the fact that dietary cholesterol is a significant risk factor in the development of heart disease (Grundy et al., 1982).

A second objective of this invention is to provide a procedure for the production of low-cholesterol shrimp which would be a high value-added product for the shrimp fishery and farming industries and at the same time significantly contribute to meet the rising demand for low-cholesterol foods.

Among the various industrial techniques currently used for reducing the cholesterol content of foods is the process known as supercritical extraction which has found various commercial applications. This process relies on the use of a supercritical fluid, e.g. a fluid heated above its critical temperature and compressed above its critical pressure. In the supercritical state, the physicochemical differences between the liquid and the gaseous phases disappear and thus, the fluid can no longer be liquefied with an increment in pressure thus becoming denser (Sihvonen et al., 1999). In this state the fluid has very peculiar thermodynamic and transport properties. Its density is relatively high, similar to that of a liquid which provides high solvent capacity while its low viscosity and high diffusivity, similar to those of a gas, provide a large penetration capacity within the sample. Due to all these properties, the speed for solute mass transfer is larger within a supercritical fluid than within a liquid (Rizvi et al., 1986). By manipulating the operating conditions the supercritical fluid has the ability to selectively extract one or more specific components, such as fats, oils, cholesterol, ketones, aldehydes and esters while leaving proteins, sugars, and other carbohydrates practically untouched (Dziezak, 1986). The most widely-used supercritical solvent in the food industry today is carbon dioxide because it possesses overwhelming advantages over other compounds. It is non-flamable, non-corrosive, non-toxic and non-pollutant. It is rather inexpensive and its critical temperature is also low (31.1° C.). This makes it very adequate for the extraction of thermally-unstable materials.

Several processes based on supercritical extraction have been implemented in the food industry with the aim of reducing the fat and cholesterol content of foods from animal origin. However, up to this day, no process has been proposed for the production of low-cholesterol shrimp.

Cully et al. (1991), Patent Application Number DE-39-29-551-A1 submitted in the Federal Republic of Germany devised a process for the removal of cholesterol and cholesterol esters from food using carbon dioxide at pressures higher than 100 bar and temperatures between 10 and 90° C. This procedure reduces the cholesterol and cholesterol esters content approximately 60-90% in meat, eggs, dairy products and animal fats.

McLachlan, et al. (1990), EP0356165, established a procedure for the extraction of esterols and lipidic components (for example, cholesterol and fat) from high-protein foods such as meat using fluids in a subcritical and supercritical state. This procedure involves an initial treatment of the product to remove all the free water, but not the total bound water. Thus, the process yields an intermediate-moisture product.

The removal of moisture is carried out through freeze-drying until the final content is from 30-55%. Supercritical carbon dioxide was used for the removal of lipids immediately separating the fraction of carbon dioxide-fat using a selective adsorbent. The product is later reconstituted using water and fat.

While it is true that a growing interest in research using supercritical fluids has occurred, no treatments have been reported in animal tissues maintaining their original shape. In the patent mentioned above, McLachlan et al. used food chunks as their sample and included an initial processing stage for size reduction. In spite of the fact that cholesterol extraction from the intact muscle structure represents significant technical difficulties due to the fibrous nature of the shrimp muscle, this invention refers to a process in which the sample maintains its original shape and fundamental geometry. This aspect is of crucial importance for final consumer acceptance. For this reason also, different shrimp species and sizes having high consumer acceptance due to their flavor and shape were included. This situation posed additional problems such as a higher cholesterol content compared to alternate species and a relatively higher size which makes cholesterol removal more difficult.

The first part of this invention pertains to the process of shrimp dehydration aimed at promoting the establishment of intramuscular channels in the food matrix to facilitate the subsequent extraction of cholesterol by allowing the proper circulation of the extracting fluid throughout the tissues. On the other hand, due to the highly perishable nature of shrimp, reduction of its moisture content allows a significant reduction of the spoilage rate during its processing and storage.

Differently from the work of McLachlan et al. (1990) wherein the free water and only a portion of the bound water are removed in order to obtain an intermediate moisture product, in the process covered in this invention the water content was reduced to only 1-10% as a result of this new standardization process where special care was taken to avoid protein denaturation, which would imply the release of asthaxanthin and thus the formation of caroteno-protein complexes having blue, green or light purple colorations.

As described in the referenced work mentioned previously, an intermediate moisture product avoids adverse effects on the sensory evaluation properties of the final product which are common in foods subjected to severe dehydration procedures resulting in a water content of less than 15%. In the present invention the final water content of the food was between 1-10% but this condition did not result in rejection by a trained sensory evaluation panel once it was reconstituted. This occurred because once the cholesterol extraction was performed, a careful methodology was developed in the subsequent reconstitution and storage steps to maintain all aspects of sensory quality at a very high level.

Several procedures were tried for the reconstitution of shrimp until an acceptable rehydration index was obtained, resulting in an optimum product. This product can not be obtained if the traditional rehydration methods, consisting of soaking shrimp in water at room temperature, are applied for long time periods.

All of these rehydration procedures were evaluated through sensory tests performed on the rehydrated and cooked shrimp. Different cooking procedures were also tested (immersion in boiling water, microwave cooking, steam cooking) until a minimal effect on the sensory properties of shrimp was obtained. The methodology described herein allows the proper rehydration of shrimp with the additional advantage that only water is used for the operation. That is, no polyphosphates, seasoning agents or other ingredients are needed to obtain an acceptable product.

In spite of the fact that a procedure for cholesterol extraction from foods has been reported previously, which comprises the stages of dehydration, cholesterol removal by supercritical extraction and product reconstitution, the methodology and operating conditions differ very significantly from those reported here and they do not apply to shrimp due to its particular geometry, configuration and muscle structure.

By applying the process proposed in the current invention, a new product can be obtained, i.e. low-cholesterol shrimp, which has acceptable sensory properties while keeping its nutritional content practically unchanged, i.e. a low fat content (1% or less) and a high protein content (15-20%).

### DESCRIPTION OF THE INVENTION

The present invention refers to a low-cholesterol shrimp obtained from any of the species from the Subgenus Litopenaeus (L. occidentalis, L. schmitti, L. setiferus, L. stylirostris, L. vannamei). The procedure is also applicable to other genus, subgenus and species of shrimp and to their different sizes. A natural variability in the content of cholesterol is present among the different shrimp species. However, the process described in this invention will work equally well with only minor adjustments in the processing variables, particularly the volume of supercritical fluid used.

A second aspect of this invention pertains to the process to obtain a low-cholesterol shrimp. For this purpose, peeled, headless shrimp are used as raw material. The proposed procedure consists of an initial dehydration step. The dehydrated shrimp immediately pass to the next processing step which consists of supercritical extraction of cholesterol using a highly selective solvent for lipids at a nominal pressure and temperature. For this purpose, supercritical extraction equipment with carbon dioxide as the supercritical fluid is utilized. The dehydrated shrimp are placed in the equipment extraction unit and carbon dioxide is compressed above its critical pressure (100-400 bar). The resulting gas enters the extraction unit supplied with a heating jacket to allow the extraction temperature to be maintained in a range from 30-60° C. and pass through the sample to remove the cholesterol. This process can be applied to any shrimp species and sizes with slight variations in the operating conditions. The discharge gas containing the extract is then passed through an expansion valve. At this point the extract is released from the gas by precipitation since a pressure differential under supercritical conditions implies a decrease in density and a lowering of the solvating capacity.

Dehydrated shrimp containing lower cholesterol content are thus obtained and reconstituted with water using a ratio of 1 to 10 mL per gram of shrimp. Rehydration is carried out by placing shrimp in a vacuum chamber at room temperature for a period of 1-5 hours. The dehydrated shrimp is steam-cooked before presentation to the final consumer in its original shape.

The final product obtained through this process is a low-cholesterol shrimp which is a non-existent product up to the time of this invention. Additionally, this product complies with all the nutritional labeling requirements established for low and reduced-cholesterol products by the Food and Drug Administration. According to such requirements a cholesterol-reduced product must contain 75% or less cholesterol than the original food from which it is obtained, and for a low-cholesterol product it must contain from 2 to 20 mg of cholesterol per serving (FDA, 1986). A standard error of 20% is allowable in these levels and therefore a cholesterol content of less than 24 mg per serving is acceptable for low cholesterol foods (FDA, 1990).

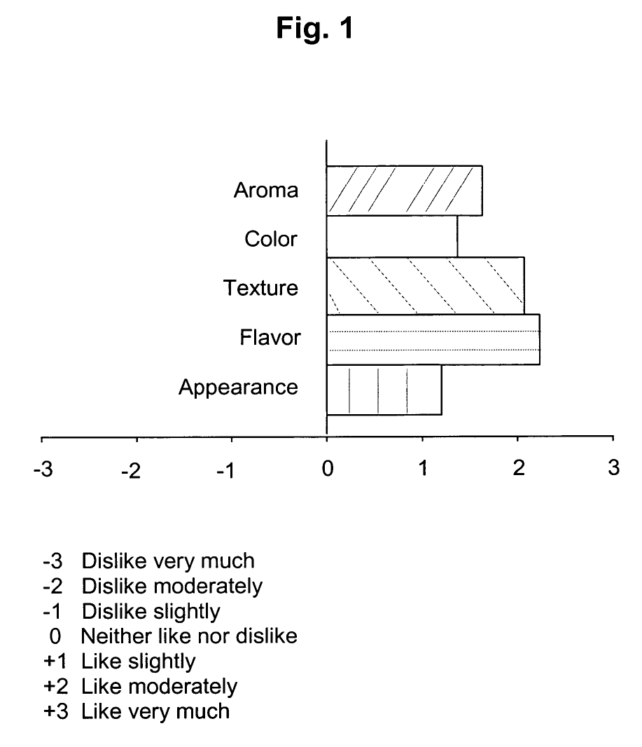

The final form of the product, subject of the present invention, consists of whole pieces of shrimp, not in chunks, or dices or powder, as has been the case with other products processed by supercritical extraction. Also, the shrimp continues to possess its original sensory characteristics in terms of texture, flavor, color and overall appearance. A sensory test was performed to evaluate each of these attributes on dehydrated and supercritically-extracted shrimp after rehydration and cooking. Such shrimp corresponded to the category of Low-cholesterol shrimp (less than 24 mg of cholesterol per serving). The test was applied to a panel of 30 untrained subjects each of whom evaluated sample color, odor, and overall appearance. The evaluation score was from −3 a +3. For a statistical analysis a non-parametric Kolmogorov-Smirnov test was performed. All attributes evaluated had a positive score from the panel members and no significant differences were evident in the acceptance scale. The texture and flavor attributes had a moderate acceptance score (+2) while smell, color and overall appearance gave a slight acceptance score (+1) (FIG. 1). In relation to smell and taste, several panelists observed that a favorable condition had been caused by the supercritical extraction process since it diminished the typically-strong smell of the product. These results show promising perspectives for the overall acceptance of low-cholesterol shrimp by the end consumer.

The following example is used to illustrate the novelty and utility of the present invention, without intention to limit any of its aspects.

### EXAMPLE

The raw material used was “blue shrimp” (Litopenaeus stylirostris) and “white shrimp” (Litopenaeus vannamei), 16-20 count per pound and deheaded, which were kept under frozen storage (−18° C.) until processed.

Shrimp are thawed, peeled and individually refrozen at −40° C. for a period of 4 hours using a quick freezing system. The shrimp are then freeze-dried until a final water content of 1-5% is reached. The temperature on the products surface as well as that inside is carefully monitored using thermocouples. When the equipment reaches a 0.1 mm Hg vacuum the following program of conditions is to be followed:

| Temperature ° C. | Time hs |
|---|---|
| 29 | 1 |
| 0 | 1 |
| 50 | 4-5 ^{a} |
| 35 | 15-20 ^{b} |
| 25 | 1-3 ^{c} |

^{a} The time will depend on the level of vacuum achieved, which should not exceed 0.2 mm Hg.
^{b} The time will depend on when the shrimp reach a maximum temperature of 5 to 10° C.
^{c} Depending on when the internal shrimp temperature becomes the same as that on their surface.

Once the freeze drying process is completed, the shrimp are ready for the extraction of cholesterol.

Cholesterol extraction is carried out in a supercritical extractor using a selective solvent (carbon dioxide) under supercritical conditions of 310 bar and 37° C. For this purpose supercritical extraction equipment with carbon dioxide is used. The extraction system consists of four basic components: a compressor or solvent pump, an extractor, a control system for pressure and temperature and a separator.

Once the shrimp have been placed within the extraction vessel the carbon dioxide is allowed to flow from the storage tank and through the compressor in order to attain the supercritical pressure of 310 bar. The resulting gas enters the extraction chamber containing a heated jacket which allows the operating temperature to be maintained at 37° C. Upon contact of carbon dioxide with the shrimp sample, a process of selective extraction begins and the gaseous carbon dioxide picks up the free cholesterol in the shrimp tissue and produces a cholesterol-rich extract. Both the volume of carbon dioxide and the flow speed are measured carefully. The flow speed should be maintained at 5.5-6.2 L/min but other flow velocities can also be used.

Once the supercritical extraction process is completed, the shrimp are subjected to rehydration using water at room temperature in a relationship of 5 mL of water per gram of shrimp. This process should take place under vacuum (533 mm Hg) for at least one hour. At the end of this period the shrimp is turned on its side and allowed to rehydrate under the same conditions for one more hour.

Upon rehydration, shrimp can be steam-cooked and later packaged in plastic containers under vacuum and quickly-frozen at −40° C.

The final product obtained with this process conditions complies with the requirements set forth by FDA for low cholesterol food products.

### Experimental Design

A Surface Response Methodology was followed during the course of experimentation with the aim of determining the optimal conditions for cholesterol removal from shrimp by supercritical extraction. A compounded-central rotatory design was applied for three independent variables with five levels for each one. The number of experimental points in the design was sufficient to prove the statistical validity of the quadratic model obtained (Arteaga et al., 1994). The variables used in the stage of cholesterol extraction were: Pressure (X₁), Volume (X₂) and Temperature (X₃). The minimum and maximum levels of the variables were fixed according to results obtained in preliminary experiments. The response variable (Y) was the amount of cholesterol remaining in the final product (dry weight basis) as determined by Gas Chromatography.

Table I shows the average values of the remaining cholesterol content in the end product and the corresponding extraction index (%).

TABLE I

| | | | | Y | | |
|---|---|---|---|---|---|---|
| | X1 | X2 | X3 | CHOLESTEROL | CHOLESTEROL | |
| | P | V | T | (mg/100 g) | (mg per serving) | EXTRACTION |
| TREATMENT | (bar) | (LCO2) | (° C.) | dry basis | wet basis | % |
| 1 | 289 | 909 | 36 | 225.10 | 52.25 | 61.99 |
| 2 | 331 | 909 | 36 | 292.71 | 67.95 | 50.56 |
| 3 | 289 | 2841 | 36 | 151.41 | 35.15 | 74.43 |
| 4 | 331 | 2841 | 36 | 81.96 | 19.26 | 85.99 |
| 5 | 289 | 909 | 38 | 224.88 | 52.20 | 62.02 |
| 6 | 331 | 909 | 38 | 211.06 | 49.00 | 64.35 |
| 7 | 289 | 2841 | 38 | 72.19 | 16.76 | 87.81 |
| 8 | 331 | 2841 | 38 | 52.02 | 12.08 | 91.21 |
| 9 | 275 | 1875 | 37 | 114.25 | 26.52 | 80.70 |
| 10 | 345 | 1875 | 37 | 99.23 | 23.03 | 83.24 |
| 11 | 310 | 250 | 37 | 366.61 | 85.11 | 38.08 |
| 12 | 310 | 3500 | 37 | 62.14 | 14.43 | 89.50 |
| 13 | 310 | 1875 | 35 | 125.44 | 29.12 | 78.81 |
| 14 | 310 | 1875 | 39 | 97.25 | 22.58 | 83.57 |
| 15 | 310 | 1875 | 37 | 99.68 | 23.14 | 83.16 |

In order to generate an equation that forecasts the effects of operating conditions (X₁, X₂, X₃) on the cholesterol quantity remaining in the final product, a regression program was run. By multiple regression analysis a quadratic model was adjusted and a final regression equation calculated:
y=6065.3575−0.608833 P+0.1424819 V−303.0457 T+0.0147289 P²−0.000884 VP+0.0000475 V²−0.191346 TP−0.003532 TV+4.7773254 T²
wherein

Y=Remaining cholesterol in final shrimp product (mg/100 g) Dry Weight Basis

P=Supercritical extraction pressure (bar)

V=Carbon dioxide volume (L)

T=Supercritical extraction temperature (° C.)

The results from the Analysis of Variance for the quadratic model of prediction are presented in Table II wherein a significant effect of the adjusted model (p≦0.05) is evident. Also, the lack of fit resulted non-significant (p>0.05). This information supports the validity of the model.

TABLE II

| SOURCE OF | | | | | | |
|---|---|---|---|---|---|---|
| VARIATION | DF | SUM OF SQUARES | MEAN SQUARE | F-Ratio | p | R² |
| Regression | 9 | 121477.4 | 13497.49 | 18.31 | 0.000202 | 0.953705 |
| Linear effect | 3 | 94030.26 | 31343.42 | 42.52 | 0.000029 | 0.738221 |
| Quadratic effect | 3 | 24653.4 | 8217.8 | 11.15 | 0.003140 | 0.193551 |
| Interactions | 3 | 2793.743 | 931.2475 | 1.26 | 0.350317 | 0.021933 |
| Total error | 8 | 5896.731 | 737.0914 | | | 0.046295 |
| Lack of fit | 5 | 5288.337 | 1057.667 | 5.22 | 0.102269 | 0.041518 |
| Pure error | 3 | 608.3936 | 202.7978 | | | 0.004776 |

According to the Analysis of Variance, some linear and quadratic effects were significant (p≦0.05) for the supercritical extraction process from shrimp, with the most important quadratic effect being that of volume.

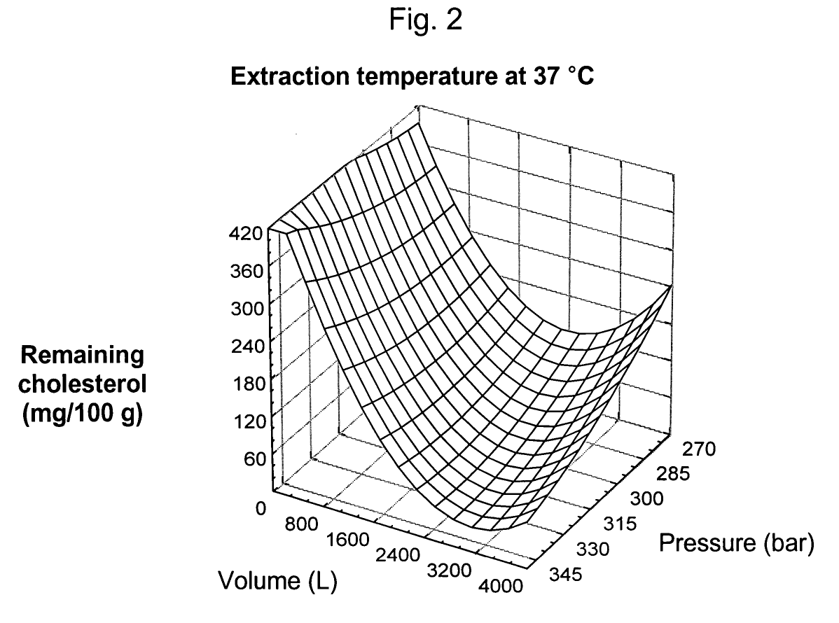

FIG. 2 shows a Surface Response graph which illustrates the final regression equation obtained through this experimentation. The effect of supercritical extraction operating conditions on the remaining shrimp cholesterol content on a dry weight basis highlights the effect of different solvent volumes required, according to the final cholesterol content desired.

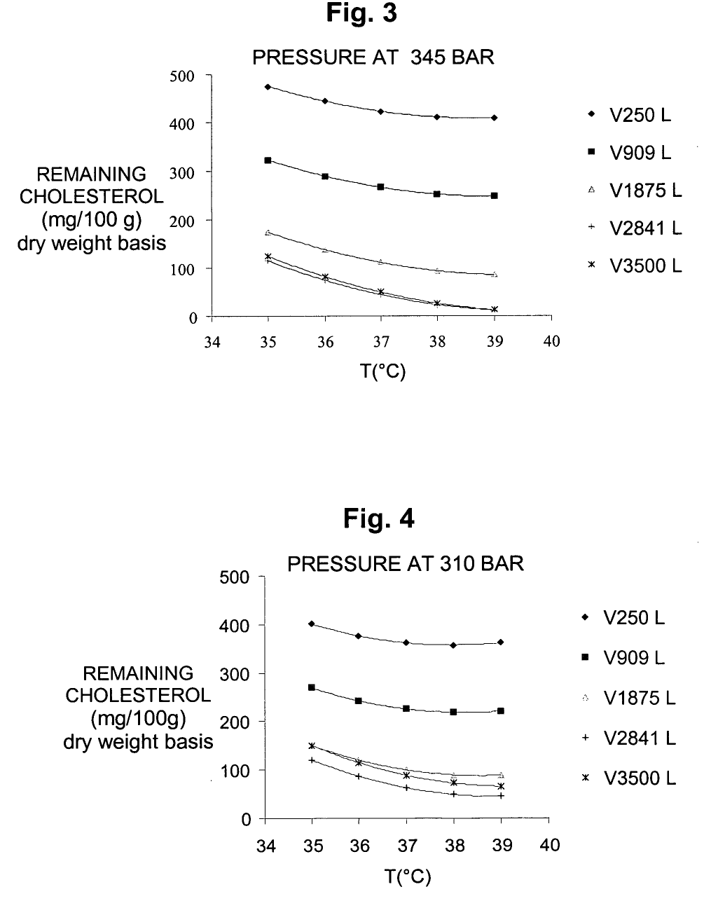

FIG. 3 shows the amount of remaining cholesterol in the shrimp (on a dry weight basis) as a function of temperature at different volumes of carbon dioxide and a pressure of 345 bar. It can be observed that at such pressure the quantity of remaining cholesterol decreases with an increase in the volume of carbon dioxide with respect to temperature. In a supercritical fluid, the effect of temperature on solubility is quite complex due to two concurrent effects. One effect tends to increase solubility with an increase in temperature, while the other tends to decrease it. As the temperature increases, the solute vapor pressure also increases and this increases solubility. On the other hand, density decreases and this tends to decrease solubility. In this experimental region density is less sensitive to temperature changes and the vapor pressure is the dominant factor so that increases in temperature increase solubility. The temperature at which a minimum of cholesterol content remains is 39° C. (11.77 mg/100 g, dry weight basis). Nevertheless the remaining amount of cholesterol (100 mg per 100 g of shrimp, on a dry weight basis) is sufficient to achieve the FDA requirements for a low-cholesterol food product once it has been rehydrated and cooked, i.e. less than 24 mg per shrimp serving on a wet basis.

From FIG. 4 it can be observed that with the conditions given in the example provided for this invention the residual cholesterol content attained is 100 mg per 100 g of shrimp on a dry weight basis. It is clear from FIGS. 3 and 4 that with different combinations of operating conditions during supercritical extraction, the same result is achieved. The conditions given are less drastic so that their adverse effects on the sensory properties of the final low-cholesterol shrimp product are significantly decreased.

### BIBLIOGRAPHY

Arteaga, G. E., E. Li-Chan, M. C. Vazquez-Arteaga and S. Nakai. 1994. Systematic experimental designs for product formula optimization. Trends in Food Science & Technology (5):243-254.
Cully J., Vollbrecht Heinz-Ruediger and Schuetz E. 1991. Process for the removal of cholesterol and/or cholesterol esters from foodstuffs. DE3929555.
Dziezak, J. D. 1986. Innovative separation process finding its way into the food industry. Food Technology. 66-69.
FDA. 1986. Proposals for Cholesterol-free and Low Cholesterol Foods. U.S. Food and Drug Administration. Fed. Register (November 25) 51:42584.
FDA. 1990. Food labeling. (1) Definition of Terms, Cholesterol-free, Low Choleserol and Reduced Cholesterol; Tentative Final Rules. U.S. Food and Drug Administration. Fed. Register (July 19) 55:29456.
Grundy, S. M., Biheimer, D., Blackburn, H., Brown, W. V., Kwiterovich, P. O., Mattson, F., Schonfeld, G., and Weidman, W. H. 1982. Rationale of the dietheart statement of the American Heart Association, Report of the Nutrition Comittee, Circulation, 65: 839A-854A.
McLachlan, C. N. S., Catchpole, O. J. and Nicol, R. S. 1990. Removal of lipids from foodstuffs. European Patent Application EP0356165A1.
Rizvi, S. S. H., A. L. Benado, J. A. Zollweg and J. A. Daniels. 1986. Supercritical fluid extraction: fundamental principles and modeling methods. Food Technology 40(6):55-65.
Sihvonen, M., E. Järvenp\ddot{aa}, V. Hietaniemi and R. Huopalahti. 1999. Advances in supercritical carbon dioxide technologies. Trends in Food Science & Technology 10:217-222.

Having described out invention, we consider a novelty and this claim of our property the contents of the following claims:

1. A product, low-cholesterol shrimp, which contains less cholesterol than its natural counterpart according to the requirements set forth by the Food and Drug Administration for reduced-cholesterol products (75% or less cholesterol than the natural product), and low-cholesterol (less than 24 mg of cholesterol per edible portion).

2. A product, low-cholesterol shrimp, with significantly less cholesterol content than its natural counterpart, adequate for human consumption, with the same nutritional properties than the natural product, i.e., a protein content from 15 to 25% and a fat content of less than 1%; a mineral content of 1-3% and a moisture content of 50-80%, which possesses sensory and overall sensory properties acceptable to the consumer.

3. The product in claim 1, as whole shrimp in any of its commercial sizes, U-10, U-12, U-15, 16-20, 21-25, 26-30, 31-35, 31/40, 36-40, 41-50, 51-60, 61-70, 71-80 and over 80.

4. The product in claim 1 as whole shrimp, preferably in 16/20 size.

5. The use of the claimed product, low-cholesterol shrimp, as a ready-to-eat product as well as its use as a flavor enhancer or its use in salads or other prepared dishes.

6. The process to obtain a low-cholesterol shrimp, which consists of dehydrating the shrimp and subjecting it to supercritical extraction using a supercritical fluid until the cholesterol content is reduced to a desirable concentration and later rehydrated and cooked.

7. The process in claim 6 which does not require a size reduction of the food and is dehydrated to a moisture content of 1-10%.

8. The process in claim 6, which consists of dehydrating the shrimp, preferably by freeze-drying to a moisture content from 1-10%, in which the frozen shrimp are placed in a freeze-drier chamber which is initially set at a temperature of −40° C. in which the equipment reaches a vacuum of 0.1 mm Hg and the following set of conditions is applied:

| Temperature ° C. | Time hs |
|---|---|
| 29 | 1 |
| 0 | 1 |
| 50 | 4-5 ^{a} |
| 35 | 15-20 ^{b} |
| 25 | 1-3 ^{c} |

^{a} The time will depend on the vacuum achieved, which should never be above 0.2 mm Hg.
^{b} The time will depend on the shrimp reaching a maximum temperature of 5-10° C.
^{c} The final condition will depend on the time required for the internal shrimp temperature to equal the surface temperature.

9. The process in claim 6, whereby the shrimp is preferably rehydrated under a vacuum (not less than 533.4 mm Hg) at room temperature, por a period of 1-5 hours, undergoing a relation of 1 to 10 mL of water per gram of shrimp.
